(19) United States
(12) Patent Application Publication
(10) Pub. No.: US 2013/0287370 A1
(43) Pub. Date: Oct. 31, 2013

(54) MULTIMEDIA IMPORTING APPLICATION

(71) Applicants: G. Garrett Groszko, Oakland, CA (US); Joshua David Fagans, Redwood City, CA (US); William Martin Bachman, San Jose, CA (US)

(72) Inventors: G. Garrett Groszko, Oakland, CA (US); Joshua David Fagans, Redwood City, CA (US); William Martin Bachman, San Jose, CA (US)

(73) Assignee: APPLE INC., Cupertino, CA (US)

(21) Appl. No.: 13/456,149

(22) Filed: Apr. 25, 2012

(51) Int. Cl. H04N 5/93; H04N 21/482

(52) U.S. Cl. 386/278; 725/38; 386/E05.003

(57) ABSTRACT

This disclosure describes systems, methods, and computer program products for importing multimedia files on a computing device. A graphical user interface (GUI) can present multimedia files as the multimedia files are imported. The multimedia files can be image files, video files, and audio files. The imported multimedia files can be presented in a parade. The user can scroll between the multimedia files presented in the parade. Multimedia files can be displayed coincident to import of other multimedia files. One or more options for adjusting the imported multimedia files can be selected while the multimedia files are presented in the parade. Actions associated with the one or more options for adjusting the imported multimedia files can be effected on a multimedia file in real-time during presentation of the multimedia file in the parade.

### TECHNICAL FIELD

This disclosure is generally related to a user interface for importing multimedia files.

### BACKGROUND

Digital media can be imported from external devices (e.g., cameras) onto personal computers for storage. Users can view the imported digital media on the personal computer once the digital media has been imported.

### SUMMARY

This disclosure describes systems, methods, and computer program products for importing multimedia files on a computing device. A graphical user interface (GUI) can present multimedia files as the multimedia files are imported. The multimedia files can be image files, video files, and audio files. The imported multimedia files can be presented in a parade. The user can pause the presented parade and can manually scroll between the multimedia files presented in the parade. Multimedia files can be displayed coincident to import of other multimedia files. One or more options for adjusting the imported multimedia files can be selected while the multimedia files are presented in the parade. Actions associated with the one or more options for adjusting the imported multimedia files can be effected on a multimedia file in real-time during presentation of the multimedia file in the parade.

In some implementations, the presented multimedia files can be adjusted by selecting an image enhancement option, sharing options, a star flag, a delete option, a red eye reduction option, an image rotation option, a rendering option, a video editing option, and a video image capturing option. In some implementations, a user can pause and/or scroll between the presented parade using voice-commands. Similarly, presented multimedia files can be adjusted voice-commands. Parades of multimedia files can be presented on one or more displays.

In some implementations, a method comprises: importing a first multimedia file from a device, the device storing a plurality of multimedia files; upon importing the first multimedia file, displaying the first multimedia file on a user interface, wherein displaying the first multimedia file is coincident to importing a second multimedia file from the device; and displaying the second multimedia file on the user interface, wherein the first and second multimedia files are displayed in a parade, and wherein the user interface includes one or more options for adjusting the first and second multimedia files.

In some implementations, a system comprises one or more processors and memory coupled to the one or more processors. The memory is configured for storing instructions, which, when executed by the one or more processors, causes the one or more processors to perform operations. The operations comprise importing a first multimedia file from a device, the device storing a plurality of multimedia files; upon importing the first multimedia file, displaying the first multimedia file on a user interface, wherein displaying the first multimedia file is coincident to importing a second multimedia file from the device; and displaying the second multimedia file on the user interface, wherein the first and second multimedia files are displayed in a parade, and wherein the user interface includes one or more options for adjusting the first and second multimedia files.

Other implementations are disclosed that are directed to methods, systems and computer-readable mediums.

Particular implementations of the multimedia importing application disclosed herein provide one or more of the following advantages. Users can view multimedia files coincident to importing of other multimedia files. The multimedia files can be presented in a parade. One or more options for adjusting the imported multimedia files can be selected while the multimedia files are presented in the parade. Actions associated with the one or more options for adjusting the imported multimedia files can be effected on a multimedia file in real-time during presentation of the multimedia file in the parade. Users can maneuver the parade in a forward and backward direction to view the imported multimedia files.

The details of the disclosed implementations are set forth in the accompanying drawings and the description below. Other features, objects, and advantages will be apparent from the description and drawings, and from the claims.

### DESCRIPTION OF DRAWINGS

FIG. 1 illustrates an exemplary GUI depicting an import launch page.

FIG. 2 illustrates an exemplary GUI depicting an imported image file.

FIG. 3 illustrates an exemplary GUI depicting imported multimedia files in a parade.

FIG. 4 illustrates an exemplary GUI depicting options for adjusting an imported multimedia file.

FIG. 5 illustrates an exemplary GUI illustrating image enhancement of an imported image file.

FIG. 6 illustrates an exemplary GUI illustrating playback of an imported video file.

FIG. 7 illustrates an exemplary GUI illustrating deletion of an imported multimedia file.

FIG. 8 illustrates an exemplary GUI depicting fields for specifying information for imported multimedia files.

FIG. 9 illustrates an alternate exemplary GUI depicting imported multimedia files in an array.

FIG. 10 illustrates an exemplary multimedia file importing process.

FIG. 11 is a block diagram of an exemplary operating environment for a device capable of running a multimedia import application.

FIG. 12 is a block diagram of an exemplary architecture for a device capable of running a multimedia import application.

The same reference symbol used in various drawings indicates like elements.

### DETAILED DESCRIPTION

The disclosure that follows describes a multimedia file importing application that presents the imported multimedia files in a display. The imported multimedia files can be presented in a parade. A first multimedia file can be displayed coincident to an import of the second multimedia file. One or more options for adjusting the imported multimedia files can be selected while the multimedia files are presented in the parade. Actions associated with the one or more options for adjusting the imported multimedia files can be effected on a multimedia file in real-time during presentation of the multimedia file in the parade.

### Exemplary GUI for Importing Multimedia Files

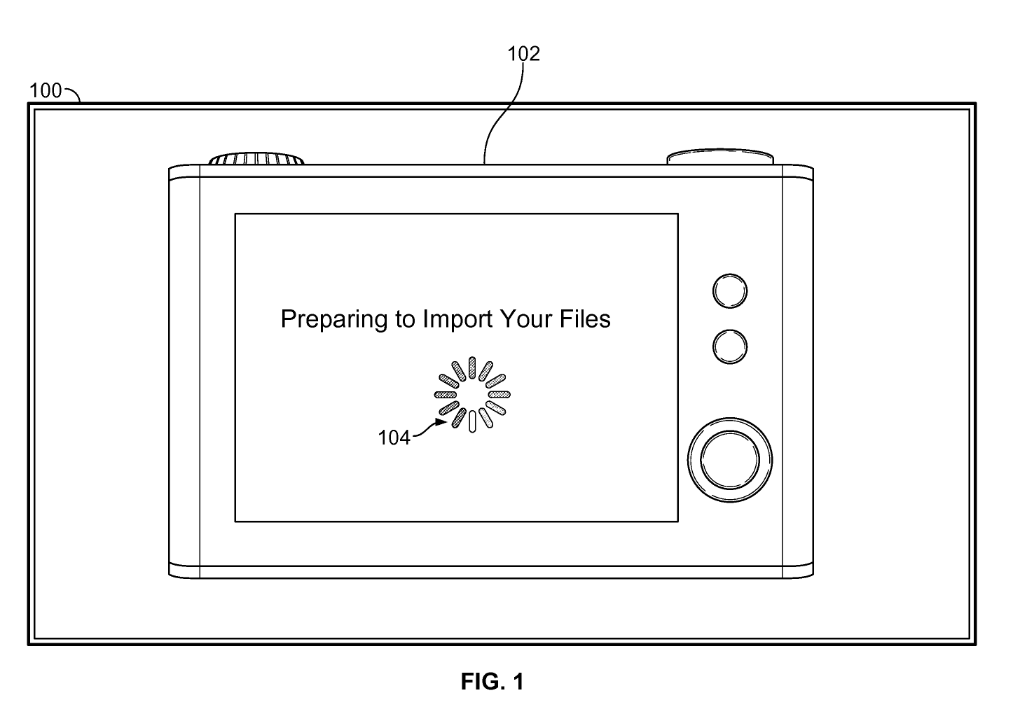

FIG. 1 illustrates an exemplary GUI 100 depicting an import launch page. The GUI 100 can be an application executing on a computing device. The launch page 100 can be displayed when multimedia files are initially being imported on a computing device. In some implementations, the launch page can be displayed when the computing device initially begins importing multimedia files. The launch page can indicate to a user that the computing device is in the process of importing multimedia files. In some implementations, the launch page can be displayed while the computing device is queuing one or more imported multimedia files for display in a parade.

The launch page can also display a graphic 102 of a camera. In some implementations, the launch page can display a graphical representation of an external device from which the computing device is importing multimedia files. For example, the launch page 100 can display a graphical representation of a particular camera model (e.g., “Camera S95”) from which the computing device is importing files. In some implementations, the launch page can display a status indicator 104 for indicating the status of the import process.

The computing device can be, for example, a personal computer, laptop, tablet, a handheld computer, a personal digital assistant, a cellular telephone, a smart phone, a media player, an email device, a game console, or other electronic device, or a combination of any two or more of these data processing devices or other data processing devices. Multimedia files can be imported, for example, from other computing devices, external devices (e.g., cameras, portable hard drives, flash drives, network-attached storage devices), or cloud-based storage systems.

A computing device can include a touch-sensitive surface. The touch-sensitive surface can process multiple simultaneous points of input, including processing data related to the pressure, degree or position of each point of input. Such processing facilitates gestures with multiple fingers, including pinching and swiping. Hereafter, when the disclosure refers “to select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radial buttons, checkboxes and any other mechanism for receiving input from a user.

The accompanying drawings show a mouse cursor but other pointers, including human fingers, can be used with devices having touch sensitive surfaces.

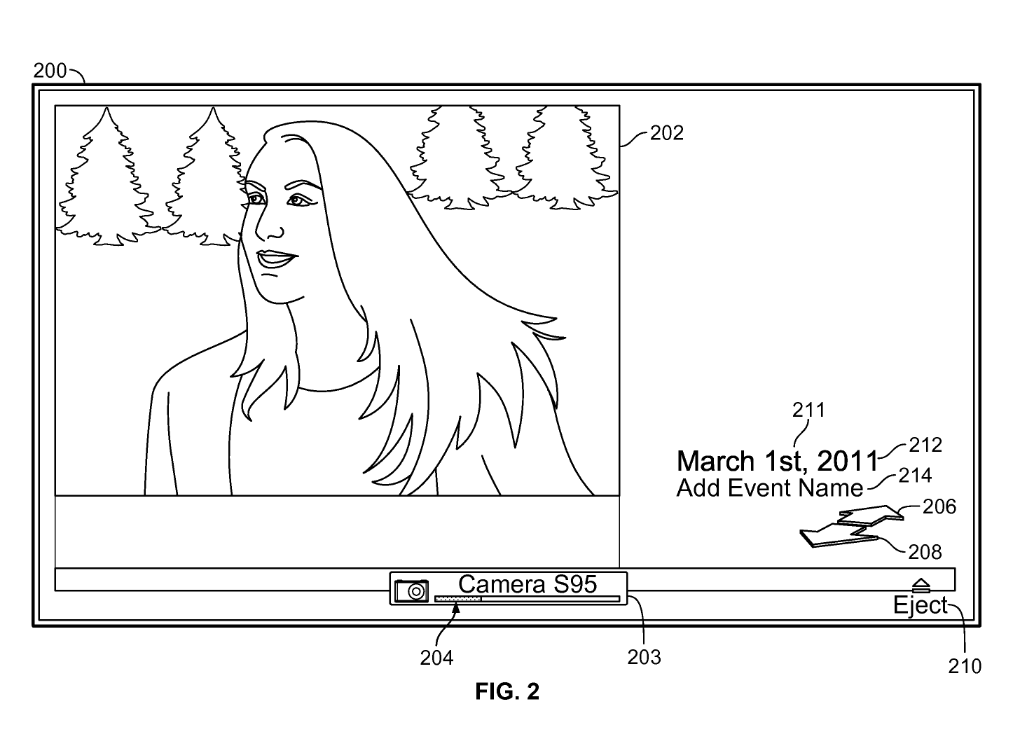

FIG. 2 illustrates an exemplary GUI 200 depicting an imported image file 202. The GUI 200 includes an imported multimedia file 202 on display, an informational display 203, scroll buttons 206 and 208, an eject button 210, a metadata display 211, and a collection display 214.

The multimedia file 202 is displayed on the GUI 200 after having been imported to a computing device on which the GUI 200 is executing. In some implementations, upon importing the multimedia file 202, the multimedia file 202 is displayed coincident to importing another multimedia file.

In some implementations, an informational display 203 that can provide the name of a source from which multimedia files are being imported. In FIG. 2, the informational display 203 indicates that the multimedia file 202 has been imported from a camera “Camera S95.” In some implementations, the informational display 203 can include a status bar 204 that indicates the status of the import process. The status bar can be updated in real-time as multimedia files are imported, thereby providing a user with an indication as to the status of the import process.

The GUI 200 can be configured to allow scrolling between displayed multimedia files. In some implementations, the GUI 200 can include buttons 206 and 208 for maneuvering between imported multimedia files that being displayed. The button 206 can be used to move a parade of displayed multimedia files in a forward direction, while the button 208 can be used to maneuver a parade of displayed multimedia files in an opposite direction. In some other implementations, scrolling between displayed multimedia files can be accomplished by providing user input from one or more external devices. For example, the scrolling can be performed by providing input from a mouse wheel.

A metadata display 211 relating to the imported multimedia file 202 is displayed. In some implementations, the metadata display 211 provides a timestamp 212 for the imported multimedia file 202. The timestamp 212 can indicate a day and time when the multimedia file 202 was taken. The timestamp 212 can be obtained from metadata associated with imported multimedia files.

In some implementations, the metadata display 211 can be an editable field. For example, a user can change the contents of the metadata display 211 to update metadata corresponding to the imported multimedia file 202. In some implementations, changes to the contents of the metadata display 211 can be propagated to metadata corresponding to one or more imported multimedia files. For example, a user can edit a timestamp 212 displayed in the metadata display 211 to a particular day and time, and have those changes propagated to metadata associated with some or all of the imported multimedia files.

In some implementations, the metadata display 211 provides a collection name 214 for one or more imported multimedia files. Similarly, the collection name 214 can be edited, and changes made to the collection name 214 can be propagated to one or more imported multimedia files. In some other implementations, the metadata display 211 provides geocoding information indicating a location where the multimedia file was taken.

An eject button 210 can be displayed on the GUI 200. In some implementations, the eject button 210 can be used to abort the import process. In some implementations, the eject button 210 can be used to disconnect the external device from which multimedia files are being imported.

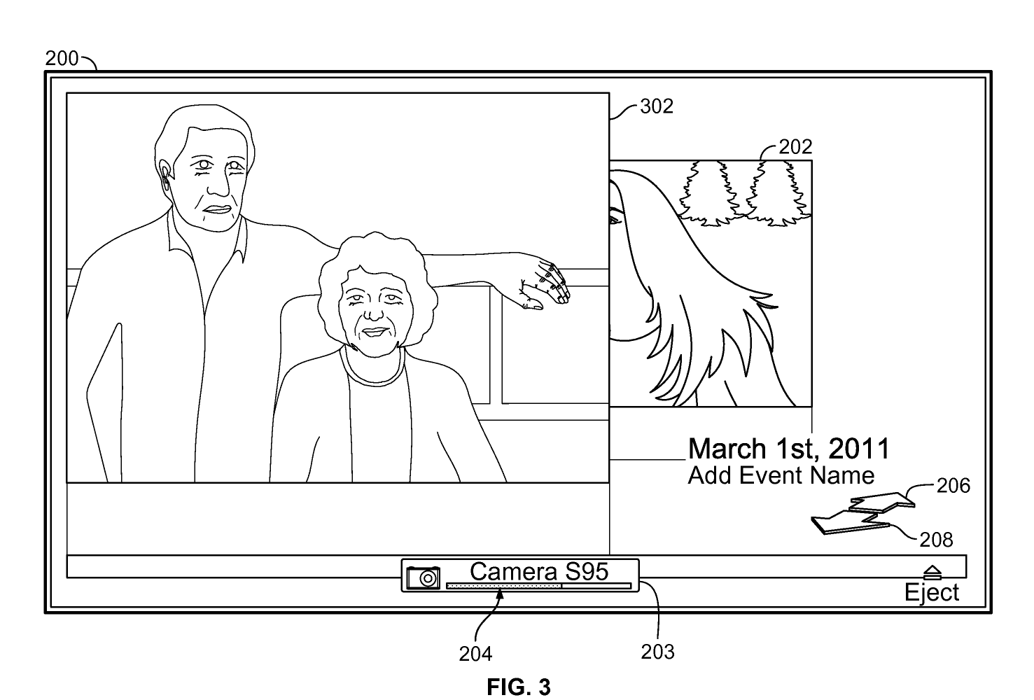

FIG. 3 illustrates an exemplary GUI 200 depicting imported multimedia files 202 and 302 in a parade. The GUI 200 includes imported multimedia files 202 and 302 on display, an informational display 203, and scroll buttons 206 and 208.

The multimedia files 202 and 302 are displayed on the GUI 200 after having been imported to a computing device on which the GUI 200 is executing. In particular, the multimedia file 302, which was imported after the multimedia file 202, is depicted as being in focus. In some implementations, upon importing the multimedia file 202, the multimedia file 202 is displayed coincident to importing the multimedia file 302. Upon importing the multimedia file 302, the multimedia files 202 and 302 can be displayed in a parade.

In some implementations, the parade in which the multimedia files 202 and 302 are displayed presents the multimedia files 202 and 302 moving in a diagonal direction, beginning from a first position (e.g., a position near the bottom-left of the GUI 200) and proceeding to a second position (e.g., a position near the top-right of the GUI 200). The displayed multimedia files 202 and 302 can be presented in an overlapping sequence, where display of the multimedia file 302 overlaps a portion of the multimedia file 202. In some implementations, the displayed multimedia files can be presented in a non-overlapping sequence. The displayed multimedia files 202 and 302 can decrease in size during the progression from the first position to the second position, thereby creating a depth effect.

The informational display 203 indicates that the multimedia files 202 and 302 have been imported from a camera “Camera S95.” In particular, the status bar 204 in the informational display 203 indicates the status of the import process has progressed. The status bar can be updated in real-time as multimedia files are imported, thereby providing a user with an indication as to the status of the import process.

The GUI 200 can be configured to allow scrolling between displayed multimedia files. In some implementations, the GUI 200 can include buttons 206 and 208 for maneuvering between imported multimedia files that being displayed. The button 206 can be used to move a parade of displayed multimedia files in a forward direction, while the button 208 can be used to maneuver a parade of displayed multimedia files in an opposite direction. For example, selecting the button 206 can move the parade in a forward direction, thereby moving the multimedia files 202 and 302 toward a second position (e.g., a position near the top-right of the GUI 200). In another example, selecting the button 208 can move the parade in an opposite direction, thereby moving the multimedia files 302 and 202 toward a first position (e.g., a position near the bottom-left of the GUI 200), thereby bringing the multimedia file 202 into focus. In some implementations, selecting the button 206 increases the speed at which imported multimedia files are displayed in the parade.

In some implementations, upon importing the multimedia file 202, a location corresponding to the multimedia file 202 can be determined. In response to the determination, an multimedia file (e.g., image, video, or audio) associated with the determined location can be presented during the importing process. For example, if the multimedia file 202 was taken in Spain, an audio file associated with Spain can be played during the importing process. In some implementations, the location can be determined based in part on geocoding information associated with the multimedia file 202.

In some implementations, upon importing the first multimedia file, a location corresponding to the multimedia file 202 can be determined. Additionally, user input for displaying a map interface corresponding to the determined location can be received and, in response to the receiving, a map interface corresponding to the determined location can be displayed.

In some implementations, one or more faces in the multimedia file 202 can be determined and, in response to the determination, names corresponding to the one or more faces can be associated with the multimedia file 202. In some implementations, multimedia files can be sorted into one or more categories based in part on the names associated with the multimedia files.

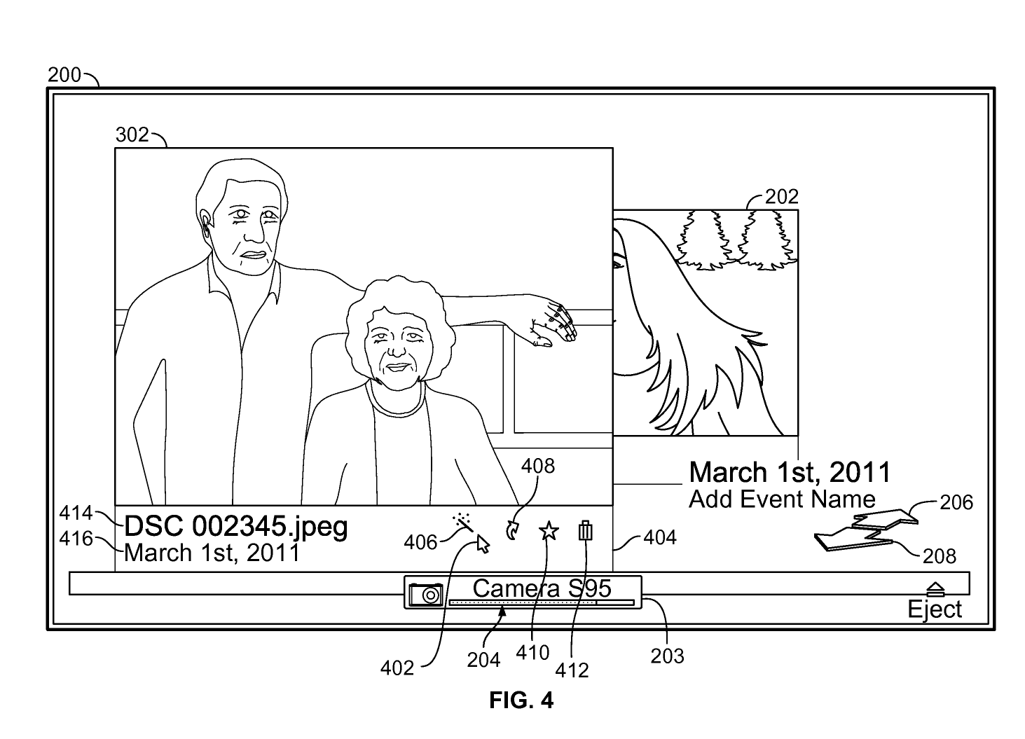

FIG. 4 illustrates an exemplary GUI 200 depicting an options display 404 for adjusting an imported multimedia file 302. The GUI 200 includes imported multimedia files 202 and 302 on display, an informational display 203, scroll buttons 206 and 208, and an options display 404.

The multimedia files 202 and 302 are displayed on the GUI 200 after having been imported to a computing device on which the GUI 200 is executing. In particular, the multimedia file 302, which was imported after the multimedia file 202, is depicted as being in focus. In some implementations, the displayed multimedia files 202 and 302 include one or more options for adjusting the multimedia files 202 and 302.

A mouse cursor 402 is shown as having been positioned over the multimedia file 302. In some implementations, the options for adjusting a multimedia file can be viewed by positioning a mouse cursor over the displayed multimedia file. In response to positioning the mouse cursor 402 over the multimedia file 302, an options display 404 is presented below the multimedia file 302. In some implementations, a multimedia file can be selected (e.g., using a glow effect) in response to positioning the mouse cursor over the multimedia file.

The options display 404 includes options for adjusting the multimedia file 302. In some implementations, imported multimedia files can be image files, video files, and audio files. The options displayed in the options display 404 can be used to edit image files, video files, and audio files. In some implementations, the options display 404 includes an image enhancement option 406, an option for sharing the multimedia file 408 (e.g., exporting the multimedia file to a storage device, e-mailing the multimedia file, or sharing the multimedia file on a website), a star flag option 410, a delete option 412. In some other implementations, options for adjusting a multimedia file can include a red eye reduction option, an image rotation option, a rendering option for converting the multimedia file into a different motif (e.g., black-and-white or sepia), a video editing option (e.g., trimming the video to shorten the length, adding or removing one or more frames, and rearranging one or more frames), and a video image capture option (e.g., exporting a frame from the video to an image file). In some implementations, displayed multimedia images are automatically enhanced. In some implementations, present options can be configured to perform multiple options to a multimedia file (e.g., image enhance, enable a star flag, mark for edit, and share the multimedia file on a social networking site).

The button 206 can be used to move a parade of displayed multimedia files in a forward direction to bring the multimedia file 202 into focus. The mouse cursor 402 can be positioned over the multimedia file 202 to reveal an options display containing options for adjusting the multimedia file 202.

In some implementations, the options display 404 can display metadata associated with the multimedia file 302. The options display 404 can display a name 414 associated with the multimedia file 302. For example, the name 414 can be a name that was assigned to the multimedia file 302 by a camera with which the multimedia file 302 was taken. The options display 404 can also display a timestamp 416 associated with the multimedia file 302. The timestamp 416 can indicate a day and time when the multimedia file 302 was taken.

In some implementations, the options display 404 can be edited to associate with the multimedia file 302 a name, a keyword, and/or a description. Users can also add keywords to custom and unique metadata that is associated with the multimedia file 302.

The timestamp 416 can be obtained from metadata associated with the multimedia file 302. In some implementations, the timestamp 212 displayed in the metadata display 211 can be populated using the timestamp 416 associated with the multimedia file 302. In some other implementations, the timestamp 212 can be edited and changes to the contents of the metadata display 211 can be propagated to metadata corresponding to the multimedia file 202, multimedia file 302, or both multimedia files 202 and 302.

Additional multimedia files can be imported during the display of the multimedia files 202 and 302. Accordingly, the status bar 204 in the informational display 203 indicates the status of the import process has progressed, thereby indicating that additional multimedia files have been imported coincident to the display of the multimedia files 202 and 302.

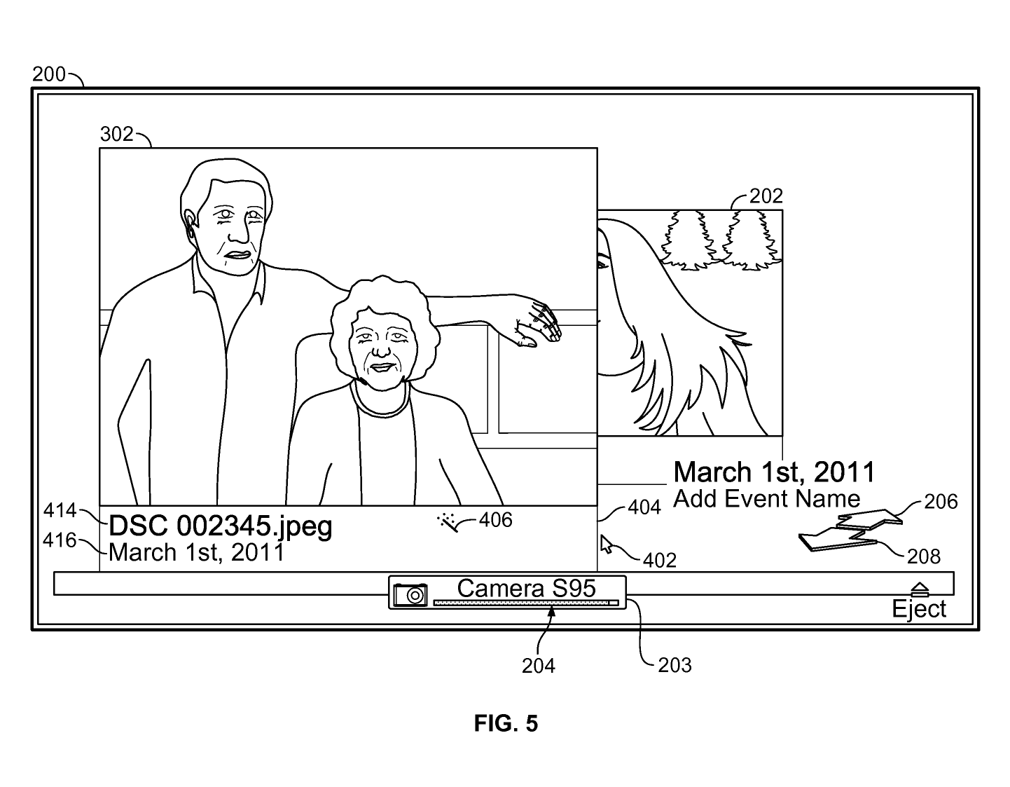

FIG. 5 illustrates an exemplary GUI 200 illustrating image enhancement of an imported multimedia file 302. The GUI 200 includes imported multimedia files 202 and 302 on display, an informational display 203, scroll buttons 206 and 208, and an options display 404.

The multimedia files 202 and 302 are displayed on the GUI 200 after having been imported to a computing device on which the GUI 200 is executing. An options display 404 is presented below the multimedia file 302. The options display 404 includes an image enhancement option 402, a name 414 associated with the multimedia file 302, and a timestamp 416 associated with the multimedia file 302.

In particular, the image enhancement option 402 is shown as having been selected. In response to the selection, the multimedia file 302 has been enhanced in quality. In some implementations, selection of an option for adjusting a multimedia file from the options display 404 results in an action associated with the option to be effected in real-time, where adjustments made to the multimedia file are reflected on the multimedia file on display in the GUI 200.

The button 206 can be used to move a parade of displayed multimedia files 202 and 302 in a forward direction. The button 208 can be used to move the parade of displayed multimedia files 202 and 302 in an opposite direction, thereby bringing the multimedia file 202 into focus. The mouse cursor 402 can be positioned over the multimedia file 202 to reveal an options display containing options for adjusting the multimedia file 202. In particular, selecting an option for adjusting the multimedia file 202 can result in an action associated with the option to be effected, in real-time, on the multimedia file 202.

Additional multimedia files can be imported during the display and adjustment of the multimedia files 202 and 302. The status bar 204 in the informational display 203 indicates the status of the import process has progressed, thereby indicating that additional multimedia files have been imported coincident to the display and adjustment of the multimedia files 202 and 302.

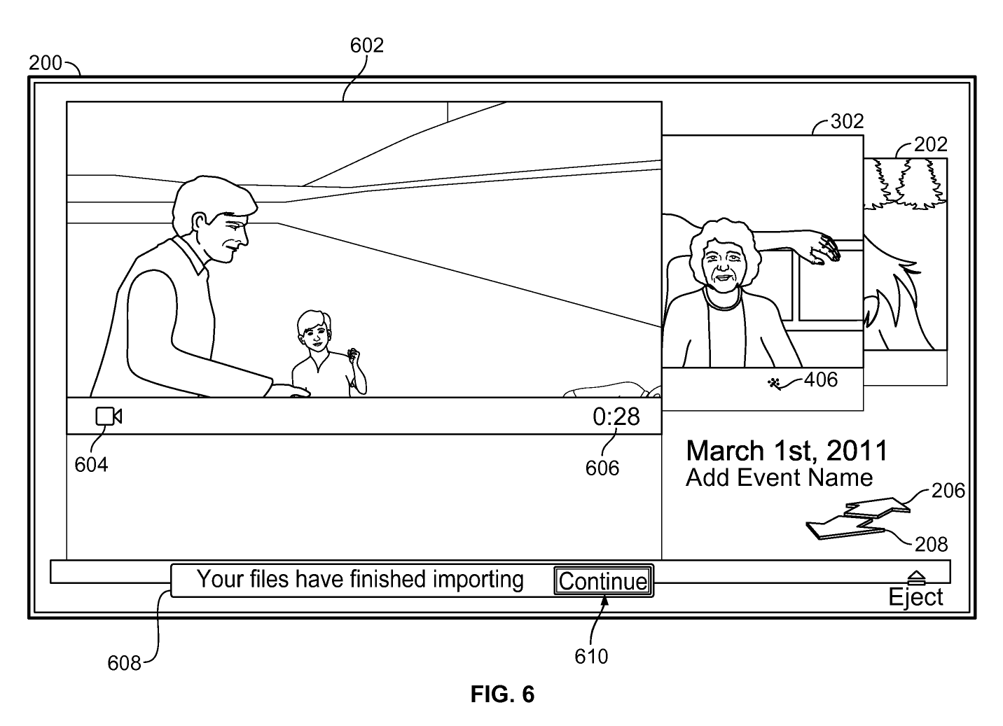

FIG. 6 illustrates an exemplary GUI illustrating playback of an imported video file 602. The GUI 200 includes imported multimedia files 202, 302, and 602, an informational display 608, and scroll buttons 206 and 208.

The multimedia files 202, 302, and 602 are displayed in a parade on the GUI 200 after having been imported to a computing device on which the GUI 200 is executing. The multimedia file 302 is displayed with the image enhancement option 406 selected, thereby indicating that the multimedia file 302 has been enhanced.

In some implementations, displaying the multimedia files 202, 302, and 602 in a parade involves presenting the multimedia files 202, 302, and 602 moving in a diagonal direction, beginning from a first position (e.g., a position near the bottom-left of the GUI 200) and proceeding to a second position (e.g., a position near the top-right of the GUI 200).

The displayed multimedia files 202, 302, and 602 can be presented in an overlapping sequence, where display of the multimedia file 602 overlaps a portion of the multimedia file 302, and where display of the multimedia file 302 overlaps a portion of the multimedia file 202. The displayed multimedia files 202, 302, and 602 can decrease in size during the progression from the first position to the second position, thereby creating a depth effect.

In some implementations, the imported multimedia file 602 is a video file, where display of the multimedia file 602 on the GUI 200 includes playback of the video file. In particular, the multimedia file 602 can be played while the multimedia files 202, 302, and 602 are displayed in the parade on the GUI 200. In some implementations, playback of the multimedia file 602 can be manipulated using one or more options (e.g., pause, rewind, and fast-forward). The multimedia file 602 can include a video icon 604 to indicate to a user that it is a video file. The multimedia file 602 can also include a video duration indicator 606 to indicate the length of the video file.

The button 206 can be used to move the parade of displayed multimedia files 202, 302, and 602 in a forward direction. The button 208 can be used to move the parade of displayed multimedia files 202, 302, and 602 in an opposite direction to bring the multimedia files 202 and 302 into focus.

The informational display 608 indicates that importing of multimedia files is complete. The information display 608 can include a button 610 to stop the parade. In some implementations, selecting the button 610 can stop the parade and proceed to a different GUI to view the imported multimedia files in an array.

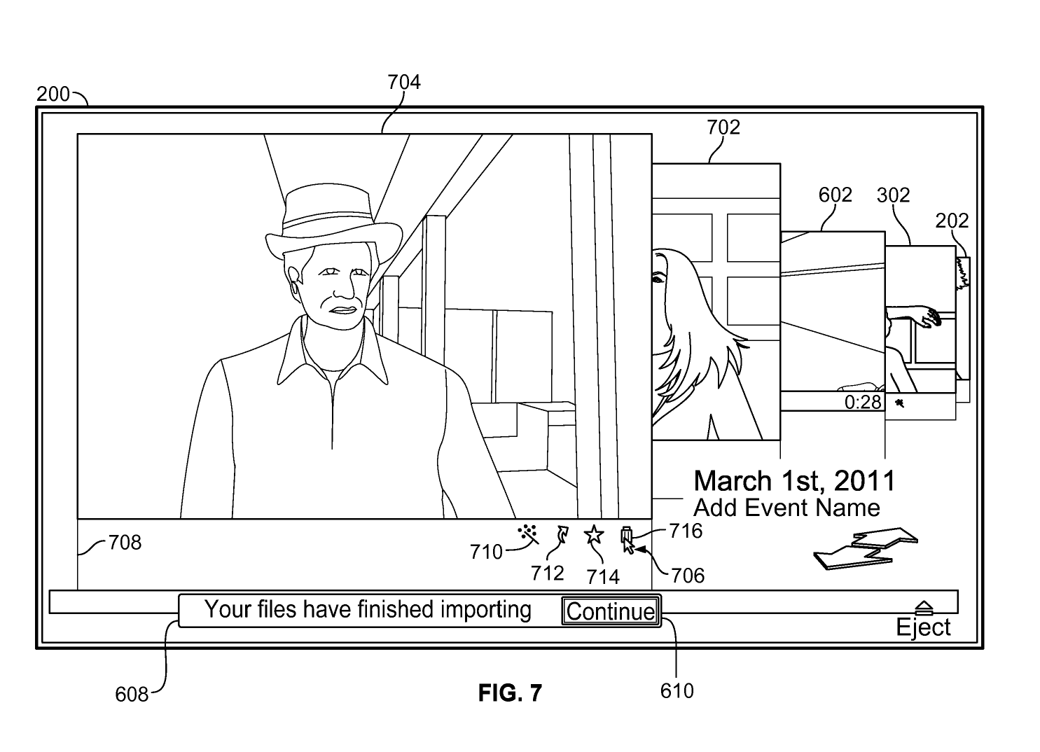

FIG. 7 illustrates an exemplary GUI 200 illustrating deletion of an imported multimedia file 704. The GUI 200 includes imported multimedia files 202, 302, 602, 702, and 704, an informational display 608, and an options display 708.

The multimedia files 202, 302, 602, 702, and 704 are displayed in a parade on the GUI 200 after having been imported to a computing device on which the GUI 200 is executing. In particular, the multimedia file 704, which was imported after the multimedia files 202, 302, 602, and 702, is depicted as being in focus.

A mouse cursor 706 is shown as having been positioned over the multimedia file 704. In some implementations, the options 710, 714, 714, and 716 for adjusting a multimedia file can be viewed by positioning a mouse cursor over the displayed multimedia file 704. In response to positioning the mouse cursor 706 over the multimedia file 704, an options display 708 is presented below the multimedia file 704.

The options display 708 includes options for adjusting the multimedia file 704. In some implementations, the multimedia file 704 is an image file and the options display 708 includes an image enhancement option 710, an option for sharing the multimedia file 712 (e.g., exporting the multimedia file to a storage device, e-mailing the multimedia file, or sharing the multimedia file on a website), a star flag option 714, and a delete option 716. In some other implementations, options for adjusting the multimedia file 704 include a red eye reduction option, an image rotation option, a rendering option for converting the multimedia file into a different motif (e.g., black-and-white or sepia), a video editing option (e.g., trimming the video to shorten the length, adding or removing one or more frames, and rearranging one or more frames), and a video image capture option (e.g., exporting a frame from the video to an image file). The mouse cursor 706 is shown as selecting the delete option 716 for the multimedia file 704. Upon selection of the delete option 716, the multimedia file 704 is flagged for deletion.

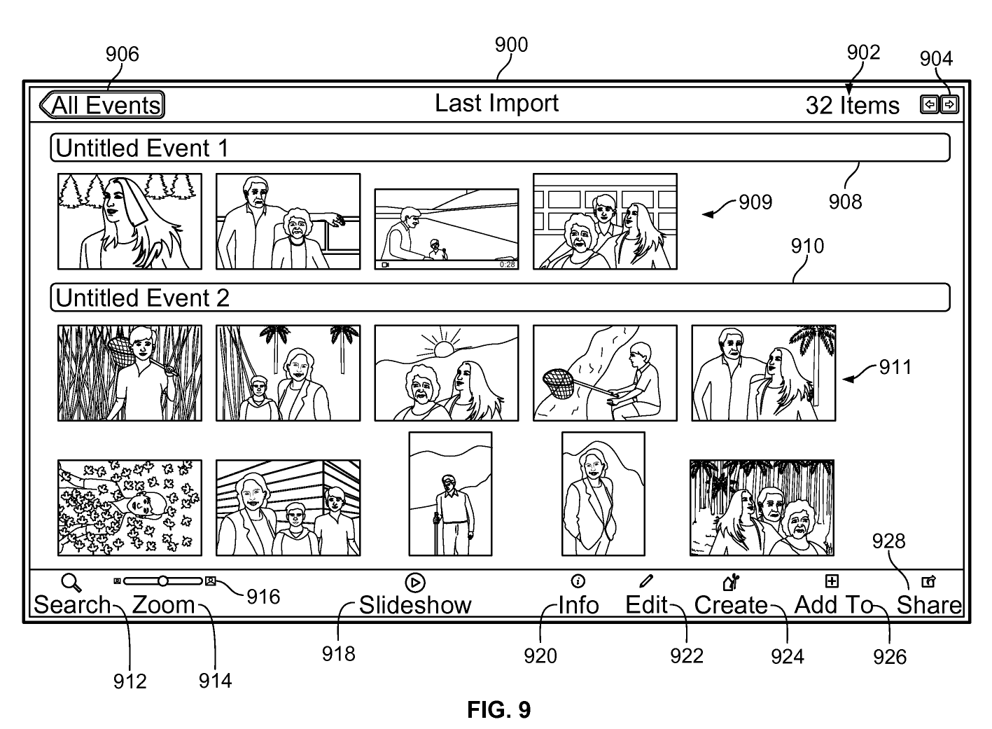

The informational display 608 indicates that importing of multimedia files is complete. The information display 608 can include a button 610 to stop the parade. In some implementations, selecting the button 610 can stop the parade and proceed to a different GUI to view the imported multimedia files in an array, as discussed in more detail in connection with FIG. 9.

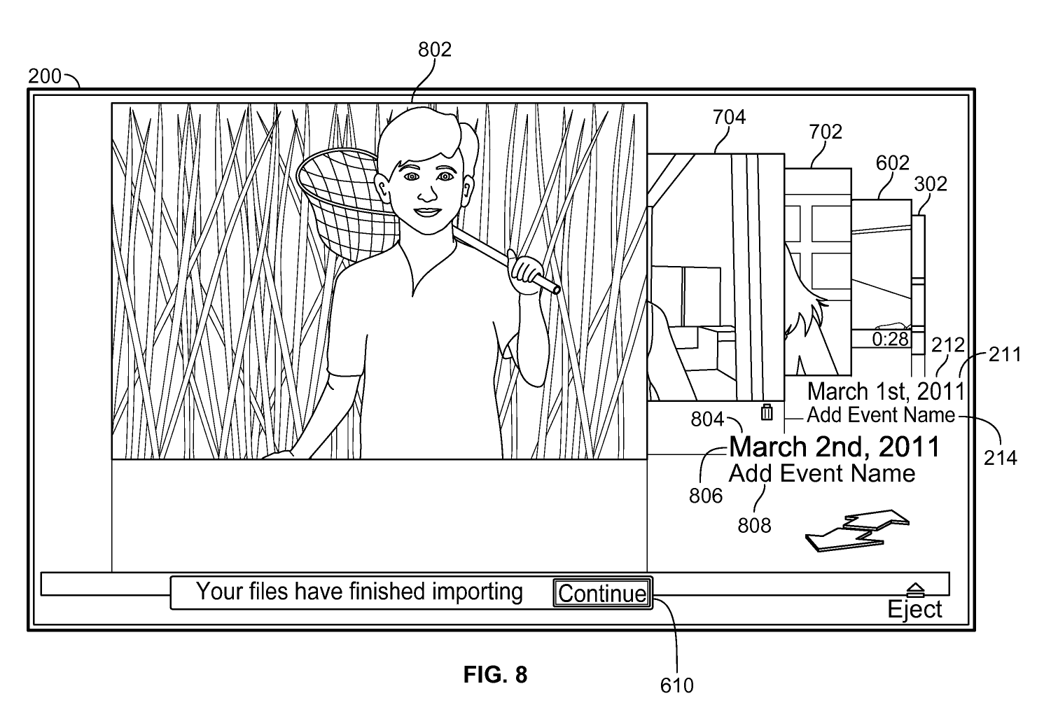

FIG. 8 illustrates an exemplary GUI depicting fields for specifying information for imported multimedia files. The GUI 200 includes imported multimedia files 302, 602, 702, 704, and 802, an informational display 608, a first metadata display 211, and a second metadata display 804. The multimedia files 302, 602, 702, 704, and 802 are displayed in a parade on the GUI 200 after having been imported to a computing device on which the GUI 200 is executing.

A first metadata display 211 relating to the imported multimedia files 302, 602, 702, and 704 is displayed. In some implementations, the metadata display 211 provides a timestamp 212 for the imported multimedia files 302, 602, 702, and 704. The timestamp 212 can indicate a day and time when the multimedia files were taken 302, 602, 702, and 704. The timestamp 212 can be obtained from metadata associated with imported multimedia files 302, 602, 702, and 704.

In some implementations, the metadata display 211 can be an editable field. For example, a user can change the contents of the metadata display 211 to update metadata corresponding to the imported multimedia file 302, 602, 702, and 704. In some implementations, changes to the contents of the metadata display 211 can be propagated to metadata corresponding to one or more imported multimedia files. For example, a user can edit a timestamp 212 displayed in the metadata display 211 to a particular day and time, and have those changes propagated to metadata associated with some or all of the imported multimedia files 302, 602, 702, and 704.

In some implementations, the metadata display 211 provides a collection name 214 for one or more imported multimedia files. Similarly, the collection name 214 can be edited, and changes made to the collection name 214 can be propagated to one or more imported multimedia files. In some other implementations, the metadata display 211 provides geocoding information indicating a location where the multimedia file was taken.

A second metadata display 804 relating to the imported multimedia file 802 is also displayed. The second metadata display 804 can be displayed when the multimedia file 802 has metadata information that differs from the multimedia files 302, 602, 702, and 704. In some implementations, the metadata display 804 provides a timestamp 806 for the imported multimedia file 802. The timestamp 806 can indicate a day and time when the multimedia file 802 was taken. The timestamp 806 can be obtained from metadata associated with the imported multimedia file 802.

In some implementations, the metadata display 804 can be an editable field. For example, a user can change the contents of the metadata display 804 to update metadata corresponding to the imported multimedia file 802. In some implementations, the metadata display 804 provides a collection name 808 for the imported multimedia file 802. Similarly, the collection name 808 can be edited, and changes made to the collection name 808 can be propagated to one or more imported multimedia files. In some other implementations, the metadata display 804 provides geocoding information indicating a location where the multimedia file 802 was taken.

FIG. 9 illustrates an alternate exemplary GUI depicting imported multimedia files in an array. The GUI 900 indicates the number 902 of multimedia files that were imported, scroll buttons 904, a back button 906, a first informational display 908, a set of imported multimedia files 909 corresponding to the first informational display 908, a second informational display 910, a set of imported multimedia files 911 corresponding to the second informational display 910, a search option 912, a zoom option 914, a slideshow option 918, an information option 920, an edit option 922, a create option 924, an add option 926, and a share option 928.

The scroll buttons 904 can be used to maneuver between pages containing additional imported multimedia files. The back button 906 can be used to return to a GUI displaying the imported multimedia files in a parade view.

The first and second informational displays 908 and 910 display collection name information relating to the sets of imported multimedia files 909 and 911, respectively. In some implementations, the informational displays 908 and 910 provide a timestamp for the sets of imported multimedia files 909 and 911, respectively. The timestamp can be obtained from metadata associated with imported multimedia files. In some implementations, the informational displays 908 and 910 can be editable fields. In some implementations, changes to the contents of the informational displays 908 and 910 can be propagated to metadata corresponding to the sets of imported multimedia files 909 and 911, respectively. In some other implementations, the informational displays 908 and 910 provide geocoding information indicating a location where the sets of multimedia files 909 and 911, respectively, were taken.

The GUI 900 also includes a search option 912 for searching for imported multimedia files. The zoom option 914 can be used to increase or decrease the zoom for a selected multimedia file using a zoom selector 916. The slideshow option 918 can be selected to trigger a slideshow presentation of the sets of imported multimedia files 909 and 911. The information option 920 can be selected to view information associated with a multimedia file. The information can include metadata information (e.g. timestamp, collection name, geocoding information) corresponding to the multimedia file.

The edit option 922 can be selected to edit a selected multimedia file. In some implementations the edit option 922 can be selected to perform one or more of the following options: image enhancement, sharing the selected multimedia file (e.g., exporting the multimedia file to a storage device, e-mailing the multimedia file, or sharing the multimedia file on a website), flagging the selected multimedia file with, deleting the selected multimedia file, performing a red eye reduction on the selected multimedia file, rotating the selected multimedia file, converting the selected multimedia file into a different motif (e.g., black-and-white or sepia). In situations where the selected multimedia file is a video, the edit option 922 can be selected to perform video editing of the selected multimedia file (e.g., trimming the video to shorten the length, adding or removing one or more frames, and rearranging one or more frames) and capturing images from the video (e.g., exporting a frame from the video to an image file).

In some implementations, a create option 924 can be selected to perform an operation using a selected multimedia file. For example, the create option 924 can be selected to create a book, a calendar, a slideshow, or an album that incorporates a selected multimedia file. In some implementations, an “add to” option 926 can be selected to include one or more selected multimedia files in an existing book, calendar, slideshow, or album.

### Exemplary Multimedia Import Process

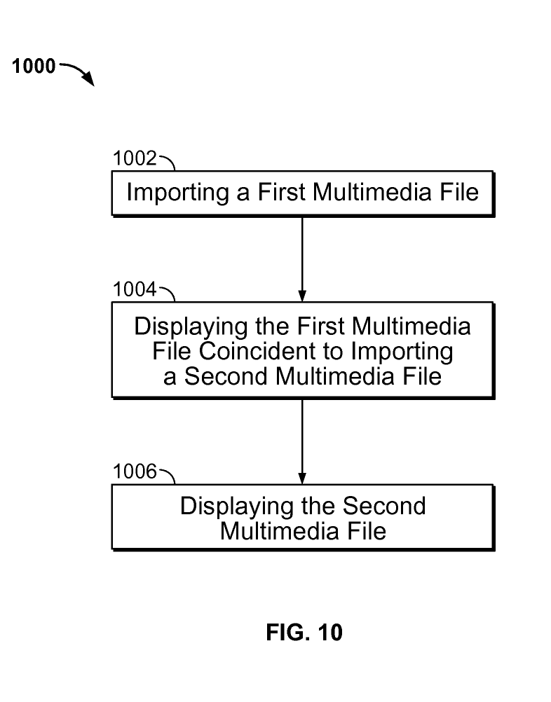

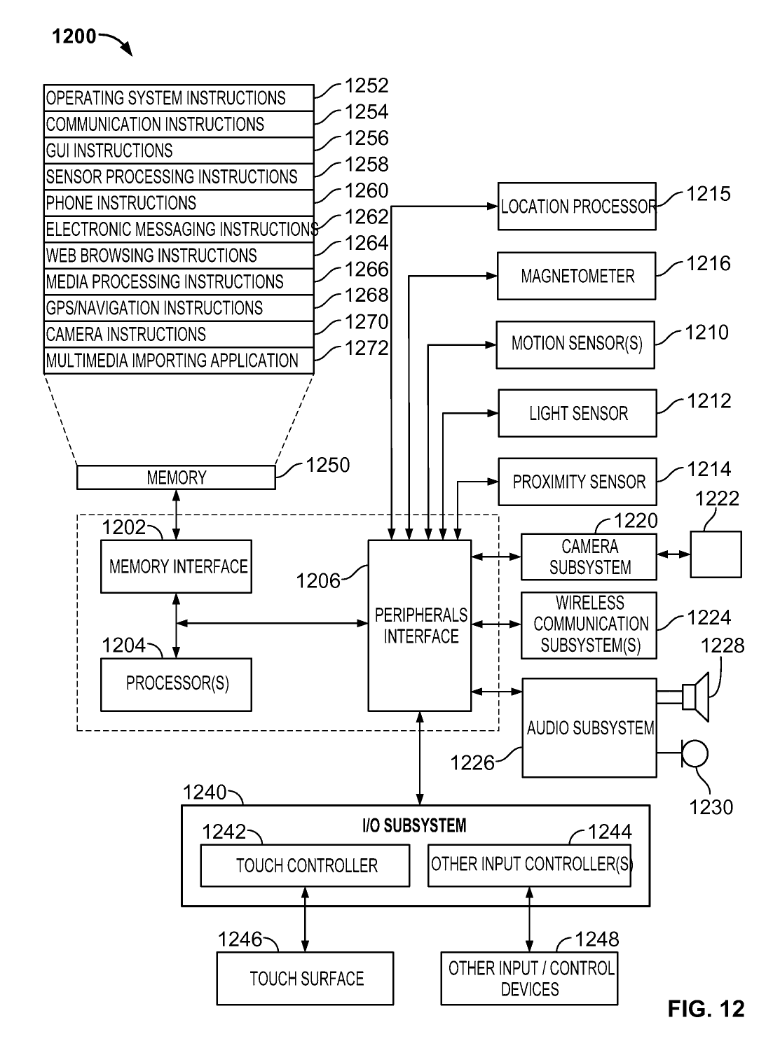

FIG. 10 illustrates an exemplary multimedia file importing process 1000. In some implementations, process 1000 can be implemented using the architecture described in reference to FIG. 12.

In some implementations, process 1000 can begin by importing a first multimedia file from a device (1002). Multimedia files can be imported, for example, from other computing devices, external devices (e.g., cameras, portable hard drives, flash drives, network-attached storage devices), or cloud-based storage systems.

Process 1000 can continue, upon importing the first multimedia file, by displaying the first multimedia file on a user interface, where displaying the first multimedia file is coincident to importing a second multimedia file from the device (1004).

Process 1000 can continue by displaying the second multimedia file on the user interface, wherein the first and second multimedia files are displayed in a parade (1006). In some implementations, the parade in which the first and second multimedia files are displayed presents the first and second multimedia files moving in a diagonal direction, beginning from a first position (e.g., a position near the bottom-left of the display) and proceeding to a second position (e.g., a position near the top-right of the display).

The displayed first and second multimedia files can be presented in an overlapping sequence, where display of the second multimedia files overlaps a portion of the first multimedia file. The displayed first and second multimedia files can decrease in size during the progression from the first position to the second position, thereby creating a depth effect.

In some implementations, the user interface includes one or more options for adjusting the first and second multimedia files. In some implementations the one or more options include an image enhancement option, sharing options, a star flag, a delete option, a red eye reduction option, an image rotation option, a rendering option, a video editing option, and a video image capture option.

### Exemplary Operating Environment

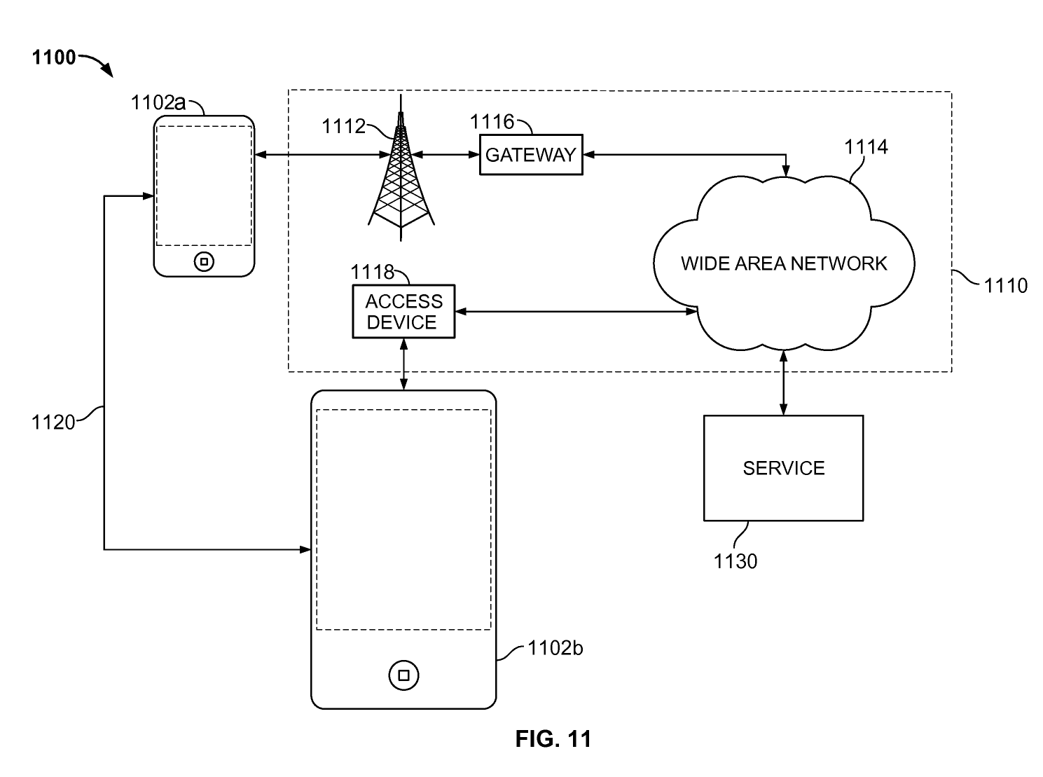

FIG. 11 is a block diagram of an exemplary operating environment for a device capable of running a multimedia file importing application. In some implementations, devices 1102a and 1102b can communicate over one or more wired or wireless networks 1110. For example, wireless network 1112 (e.g., a cellular network) can communicate with a wide area network (WAN) 1114 (e.g., the Internet) by use of gateway 1116. Likewise, access device 1118 (e.g., IEEE 802.11g wireless access device) can provide communication access to WAN 1114. Devices 1102a, 1102b can be any device capable of displaying GUIs of the disclosed multimedia file importing application, including but not limited to portable computers, smart phones and electronic tablets. In some implementations, the devices 1102a, 1102b do not have to be portable but can be a desktop computer, television system, kiosk system or the like.

In some implementations, both voice and data communications can be established over wireless network 1112 and access device 1118. For example, device 1102a can place and receive phone calls (e.g., using voice over Internet Protocol (VoIP) protocols), send and receive e-mail messages (e.g., using SMPTP or Post Office Protocol 3 (POP3)), and retrieve electronic documents and/or streams, such as web pages, photographs, and videos, over wireless network 1112, gateway 1116, and WAN 1114 (e.g., using Transmission Control Protocol/Internet Protocol (TCP/IP) or User Datagram Protocol (UDP)). Likewise, in some implementations, device 1102b can place and receive phone calls, send and receive e-mail messages, and retrieve electronic documents over access device 1118 and WAN 1114. In some implementations, device 1102a or 1102b can be physically connected to access device 1118 using one or more cables and access device 1118 can be a personal computer. In this configuration, device 1102a or 1102b can be referred to as a “tethered” device.

Devices 1102a and 1102b can also establish communications by other means. For example, wireless device 1102a can communicate with other wireless devices (e.g., other devices 1102a or 1102b, cell phones) over the wireless network 1112. Likewise, devices 1102a and 1102b can establish peer-to-peer communications 1120 (e.g., a personal area network) by use of one or more communication subsystems, such as the Bluetooth™ communication devices. Other communication protocols and topologies can also be implemented.

Devices 1102a or 1102b can communicate with service 1130 over the one or more wired and/or wireless networks 1110. For example, service 1130 can be an online store or university that provides Web pages to client devices that include the features described in reference to FIGS. 1-9.

Device 1102a or 1102b can also access other data and content over one or more wired and/or wireless networks 1110. For example, content publishers, such as news sites, Really Simple Syndication (RSS) feeds, Web sites and developer networks can be accessed by device 1102a or 1102b. Such access can be provided by invocation of a web browsing function or application (e.g., a browser) running on the device 1102a or 1102b.

Devices 1102a and 1102b can exchange files over one or more wireless or wired networks 1110 either directly or through service 1130.

### Exemplary Device Architecture

FIG. 12 is a block diagram of an exemplary architecture for a device capable of running the disclosed multimedia file importing application. Architecture 1200 can be implemented in any device for generating the features described in reference to FIGS. 1-9, including but not limited to portable or desktop computers, smart phones and electronic tablets, television systems, game consoles, kiosks and the like. Architecture 1200 can include memory interface 1202, data processor(s), image processor(s) or central processing unit(s) 1204, and peripherals interface 1206. Memory interface 1202, processor(s) 1204 or peripherals interface 1206 can be separate components or can be integrated in one or more integrated circuits. The various components can be coupled by one or more communication buses or signal lines.

Sensors, devices, and subsystems can be coupled to peripherals interface 1206 to facilitate multiple functionalities. For example, motion sensor 1210, light sensor 1212, and proximity sensor 1214 can be coupled to peripherals interface 1206 to facilitate orientation, lighting, and proximity functions of the device. For example, in some implementations, light sensor 1212 can be utilized to facilitate adjusting the brightness of touch surface 1246. In some implementations, motion sensor 1210 (e.g., an accelerometer, gyros) can be utilized to detect movement and orientation of the device. Accordingly, display objects or media can be presented according to a detected orientation (e.g., portrait or landscape).

Other sensors can also be connected to peripherals interface 1206, such as a temperature sensor, a biometric sensor, or other sensing device, to facilitate related functionalities.

Location processor 1215 (e.g., GPS receiver) can be connected to peripherals interface 1206 to provide geo-positioning. Electronic magnetometer 1216 (e.g., an integrated circuit chip) can also be connected to peripherals interface 1206 to provide data that can be used to determine the direction of magnetic North. Thus, electronic magnetometer 1216 can be used as an electronic compass.

Camera subsystem 1220 and an optical sensor 1222, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 1224. Communication subsystem(s) 1224 can include one or more wireless communication subsystems. Wireless communication subsystems 1224 can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The specific design and implementation of the communication subsystem 1224 can depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., WiFi, WiMax, or 3G networks), code division multiple access (CDMA) networks, and a Bluetooth™ network. Communication subsystems 1224 may include hosting protocols such that the device may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 1226 can be coupled to a speaker 1228 and one or more microphones 1230 to facilitate voice-enabled functions, such as voice recognition, voice replication, digital recording, and telephony functions.

I/O subsystem 1240 can include touch controller 1242 and/or other input controller(s) 1244. Touch controller 1242 can be coupled to a touch surface 1246. Touch surface 1246 and touch controller 1242 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 1246. In one implementation, touch surface 1246 can display virtual or soft buttons and a virtual keyboard, which can be used as an input/output device by the user.

Other input controller(s) 1244 can be coupled to other input/control devices 1248, such as one or more buttons, rocker switches, thumb-wheel, infrared port, USB port, and/or a pointer device such as a stylus. The one or more buttons (not shown) can include an up/down button for volume control of speaker 1228 and/or microphone 1230.

In some implementations, device 1200 can present recorded audio and/or video files, such as MP3, AAC, and MPEG files. In some implementations, device 1200 can include the functionality of an MP3 player and may include a pin connector for tethering to other devices. Other input/output and control devices can be used.

Memory interface 1202 can be coupled to memory 1250. Memory 1250 can include high-speed random access memory or non-volatile memory, such as one or more magnetic disk storage devices, one or more optical storage devices, or flash memory (e.g., NAND, NOR). Memory 1250 can store operating system 1252, such as Darwin, RTXC, LINUX, UNIX, OS X, WINDOWS, or an embedded operating system such as VxWorks. Operating system 1252 may include instructions for handling basic system services and for performing hardware dependent tasks. In some implementations, operating system 1252 can include a kernel (e.g., UNIX kernel).

Memory 1250 may also store communication instructions 1254 to facilitate communicating with one or more additional devices, one or more computers or servers. Communication instructions 1254 can also be used to select an operational mode or communication medium for use by the device, based on a geographic location (obtained by the GPS/Navigation instructions 1268) of the device. Memory 1250 may include graphical user interface instructions 1256 to facilitate graphic user interface processing, such as generating the GUIs shown in FIGS. 1-9; sensor processing instructions 1258 to facilitate sensor-related processing and functions; phone instructions 1260 to facilitate phone-related processes and functions; electronic messaging instructions 1262 to facilitate electronic-messaging related processes and functions; web browsing instructions 1264 to facilitate web browsing-related processes and functions and display GUIs described in reference to FIGS. 1-9; media processing instructions 1266 to facilitate media processing-related processes and functions; GPS/Navigation instructions 1268 to facilitate GPS and navigation-related processes; camera instructions 1270 to facilitate camera-related processes and functions; and instructions 1272 for a multimedia importing application that is capable of importing multimedia files, as described in reference to FIGS. 1-10. The memory 1250 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 1250 can include additional instructions or fewer instructions. Furthermore, various functions of the mobile device may be implemented in hardware and/or in software, including in one or more signal processing and/or application specific integrated circuits.

What is claimed is:

1. A method comprising:
importing, by a first device, a first multimedia file from a second device, the second device storing a plurality of multimedia files;
upon importing the first multimedia file, displaying the first multimedia file on a user interface associated with the first device;
importing, by the first device, a second multimedia file from the second device concurrently with displaying the first multimedia file on the user interface associated with the first device; and
upon importing the second multimedia file, displaying the first and second multimedia files in a parade on the user interface, and wherein the user interface is configured to present timestamps associated with at least one of the first or second multimedia files indicating when the first or second multimedia files were taken.

2. The method of claim 1, wherein the user interface is configured to allow scrolling between display of the first and second multimedia files, wherein the scrolling includes moving the parade in a forward direction or in an opposite direction.

3. The method of claim 1, wherein the user interface includes one or more fields for specifying information relating to the first and second multimedia files.

4. The method of claim 3, comprising:
receiving a user input associated with changing the one or more fields; and
in response to receiving the user input, propagating changes to the information relating to at least one of the first and the second multimedia files.

5. (canceled)

6. The method of claim 3, wherein the information is geocoding information indicating a location where the first or the second multimedia file was created.

7. The method of claim 1, wherein the user interface is configured to present one or more options for adjusting the first or the second multimedia file upon user selection of the first or the second multimedia file, the one or more options including:
an image enhancement option;
an option for sharing at least one of the first or the second multimedia file using one of exporting to a storage device, emailing or sharing on a website;
an option for enabling a star flag;
a delete option for deleting the selected multimedia file;
a red eye reduction option for performing a red eye reduction on the selected multimedia file;
an image rotation option for rotating the selected multimedia file;
a rendering option for converting the multimedia file into a different motif;
a video editing option; and
a video image capture option for exporting a frame from the selected multimedia file to an image file, wherein the selected multimedia file includes video.

8. The method of claim 7, wherein upon selection of an option from the one or more options for adjusting the first or the second multimedia files, an action associated with the option is effected in real-time.

9. The method of claim 1, wherein displaying the first and second multimedia files in the parade comprises at least one of:
presenting the first and second multimedia files in a sequence, wherein display of the second multimedia file overlaps a portion of the displayed first multimedia file, or
presenting the first and second multimedia files moving in one direction beginning from a first position and proceeding to a second position with a depth effect such that the first and second multimedia files decrease in size during progression from the first position to the second position.

10. The method of claim 1, wherein the parade is paused in response to user input.

11. The method of claim 10, wherein the user input comprises positioning a mouse cursor over a displayed multimedia file, the method comprising:
in response to the user input positioning the mouse cursor over a displayed multimedia file, selecting the displayed multimedia file; and
presenting, on the user interface, one or more options for adjusting the selected multimedia file.

12. The method of claim 1, wherein the first multimedia file includes video, and wherein displaying the first multimedia file comprises playback of the video while the first and the second multimedia files are displayed in the parade.

13. The method of claim 1, wherein importing the first multimedia file comprises:
determining a location corresponding to the first multimedia file using information associated with the first multimedia file; and
in response to the determination, presenting, on the user interface, a third multimedia file associated with the determined location while the first multimedia file is being imported.

14. The method of claim 13, wherein the location is determined based in part on geocoding information associated with the first multimedia file.

15. The method of claim 1, comprising:
upon importing the first multimedia file, determining a location corresponding to the first multimedia file;
receiving user input for displaying a map interface corresponding to the determined location; and
in response to receiving the user input, displaying on the user interface the map interface corresponding to the determined location.

16. The method of claim 1, comprising:
determining one or more faces in the first multimedia file; and
in response to the determination, associating names corresponding to the one or more faces with the first multimedia file.

17. The method of claim 1, wherein the first and second multimedia files include images and wherein displaying the first and second multimedia files comprises:
automatically enhancing the images; and
displaying the first and second multimedia files with the automatically enhanced images.

18. A system comprising:
one or more processors;
memory coupled to the one or more processors and configured for storing instructions, which, when executed by the one or more processors, causes the one or more processors to perform operations comprising:
importing, by a first device, a first multimedia file from a second device, the second device storing a plurality of multimedia files;
upon importing the first multimedia file, displaying the first multimedia file on a user interface associated with the first device;
importing, by the first device, a second multimedia file from the second device concurrently with displaying the first multimedia file on the user interface associated with the first device; and
upon importing the second multimedia file, displaying the first and second multimedia files in a parade on the user interface, and wherein the user interface is configured to present timestamps associated with at least one of the first or second multimedia files indicating when the first or second multimedia files were taken.

19. The system of claim 18, wherein the user interface is configured to allow scrolling between display of the first and second multimedia files, wherein the scrolling includes moving the parade in a forward direction or in an opposite direction.

20. The system of claim 18, wherein the user interface includes one or more fields for specifying information relating to the first and second multimedia files.

21. The system of claim 20, comprising:
receiving a user input associated with changing the one or more fields; and
in response to receiving the user input, propagating changes to the information relating to at least one of the first and the second multimedia files.

22. (canceled)

23. The system of claim 20, wherein the information is geocoding information indicating a location where the first or the second multimedia file was created.

24. The system of claim 18, wherein the user interface is configured to present one or more options for adjusting the first or the second multimedia file upon user selection of the first or the second multimedia file, the one or more options including:
an image enhancement option;
an option for sharing at least one of the first or the second multimedia file using one of exporting to a storage device, emailing or sharing on a website;
an option for enabling a star flag;
a delete option for deleting the selected multimedia file;
a red eye reduction option for performing a red eye reduction on the selected multimedia file;
an image rotation option for rotating the selected multimedia file;
a rendering option for converting the multimedia file into a different motif;
a video editing option; and
a video image capture option for exporting a frame from the selected multimedia file to an image file, wherein the selected multimedia file includes video.

25. The system of claim 24, wherein upon selection of an option from the one or more options for adjusting the first or the second multimedia files, an action associated with the option is effected in real-time.

26. The system of claim 18, wherein displaying the first and second multimedia files in the parade comprises at least one of:
presenting the first and second multimedia files in a sequence, wherein display of the second multimedia file overlaps a portion of the displayed first multimedia file, or
presenting the first and second multimedia files moving in one direction beginning from a first position and proceeding to a second position with a depth effect such that the first and second multimedia files decrease in size during progression from the first position to the second position.

27. The system of claim 18, wherein the parade is paused in response to user input.

28. The system of claim 27, wherein the user input comprises positioning a mouse cursor over a displayed multimedia file, the system comprising:
in response to the user input positioning the mouse cursor over a displayed multimedia file, selecting the displayed multimedia file; and
presenting, on the user interface, one or more options for adjusting the selected multimedia file.

29. The system of claim 18, wherein the first multimedia file includes video, and wherein displaying the first multimedia file comprises playback of the video while the first and the second multimedia files are displayed in the parade.

30. The system of claim 18, wherein importing the first multimedia file comprises:
determining a location corresponding to the first multimedia file using information associated with the first multimedia file; and
in response to the determination, presenting, on the user interface, a third multimedia file associated with the determined location while the first multimedia file is being imported.

31. The system of claim 30, wherein the location is determined based in part on geocoding information associated with the first multimedia file.

32. The system of claim 18, comprising:
upon importing the first multimedia file, determining a location corresponding to the first multimedia file;
receiving user input for displaying a map interface corresponding to the determined location; and
in response to receiving the user input, displaying on the user interface the map interface corresponding to the determined location.

33. The system of claim 18, comprising:
determining one or more faces in the first multimedia file; and
in response to the determination, associating names corresponding to the one or more faces with the first multimedia file.

34. The system of claim 18, wherein the first and second multimedia files include images and wherein displaying the first and second multimedia files comprises:
automatically enhancing the images; and
displaying the first and second multimedia files with the automatically enhanced images.
